(19) United States
(12) Patent Application Publication
(10) Pub. No.: US 2018/0374053 A1
(43) Pub. Date: Dec. 27, 2018

(54) EMAIL AWARENESS TOOL

(71) Applicant: Xerox Corporation, Norwalk, CT (US)

(72) Inventors: Jutta K. Willamowski, Grenoble (FR); M. Antonietta Grasso, Grenoble (FR); Yves Hoppenot, Notre Dame de Mesage (FR); Celile Boulard, Grenoble (FR)

(73) Assignee: Xerox Corporation, Norwalk, CT (US)

(21) Appl. No.: 15/630,219

(22) Filed: Jun. 22, 2017

(51) Int. Cl. G06Q 10/10; H04L 29/08; G06F 17/30

(52) U.S. Cl. CPC G06Q 10/107; G06F 17/30705; H04L 29/08675

(57) ABSTRACT

Outgoing emails and threads are compared to performance indicators, to identify problematic email behavior, and the problematic email behavior is matched to suggestions for changing email behavior and to explanations of how the outgoing emails containing the problematic email behavior cause undesirable incoming emails. The problematic email behavior is also compared to goal standards, to produce email behavior targets and goals. Behavioral feedback related to the problematic email behavior is provided using, for example, a dashboard display. The behavioral feedback can include suggestions for changing email behavior, email behavior targets and goals, societal email behavior comparisons relative to others, etc., links between the outgoing emails and behavior of others, an explanation of how the outgoing email impacts the quantity and quality of the incoming emails, etc.

### BACKGROUND

Systems and methods herein generally relate to email systems, and more particularly to monitoring email accounts to improve email behavior.

Commentators have highlighted the fact that the number of Facebook accounts has recently reached the (psychological) threshold of one billion. Although this is a remarkable sign of worldwide diffusion, it should be remembered that the number of active email accounts, that is the number of accounts that have been actually installed and accessed at least once within the last 3 months recently passed the threshold of four billion, and this number keeps growing to over 5 billion expected by the end of 2018 (a steady growth rate of 6%).

It has been reported that the total number of worldwide email users, including both business and consumer users, is also increasing from over 2.5 billion in 2014 to over 2.8 billion in 2018, and this is not contrasting the increasing pervasiveness of mobile devices, which rather bring more than 1 billion mobile users to accessing their emails from every place where there is an internet connection. Even among the young, a recent survey by the National Cyber Security Alliance and Microsoft showed that almost three out of ten teens (aged 13 to 18) use Gmail and this is the second most used application (behind YouTube). This means that although the spread of social media is a fact under the eyes of everyone, email is still nowadays, after 40 years from its first adoption in an organizational domain, the most pervasive communication medium, especially in the business world, where it is estimated that over 187 billion emails were sent and received every day in 2013.

With these figures in mind it is no surprise that there is a growing concern that email use 1) is one of the major sources of stress at work, 2) affects organizational effectiveness, 3) contributes to the carbon footprint in a non-negligible way, and 4) disrupts personal life by keeping employees reachable anytime and anywhere. Work organizations are thus starting to search for a solution to counterbalance the pervasive use of email and its negative effects.

A typical approach often adopted at the organizational level to relieve employees from email overload and related stress is to restrict the access to email services, e.g., limiting email delivery to business hours only, introducing email-free work days, or automatically deleting all incoming emails while employees are on holidays.

However, all these solutions impose top-down strict limits and policies on the employees and fail to acknowledge that email overload is also and primarily a symptom of organizational issues and the lack of best practices.

### SUMMARY

Various methods herein automatically monitor an email account by, for example, monitoring an email server containing outgoing emails and incoming emails that are sent and received to and from the email account (e.g., using a processor in communication with the email server over a computer network). The outgoing emails can also include draft emails that are being prepared to be sent, before being sent, and the email server allows the email account to be accessed from multiple computerized devices over the computer network.

The methods herein automatically compare the outgoing emails and email threads to performance indicators, using the processor, to identify the problematic email behavior. The performance indicators can include, for example, the number of email recipients addressed in the outgoing emails, the subject matter within a regarding line of the outgoing emails, the length, content, and structure of text within a body of the outgoing emails, the number, and size of, attachments to the outgoing emails, the length, breadth, intensity, and continuity of the email threads, the ratios of the outgoing emails that remain without reply within the email threads, the repetitive emails within the email threads, etc.

The process of comparing the outgoing emails and email threads to the performance indicators can use different comparisons based on whether an outgoing email is internal to an organization or external, and whether an outgoing email is address to recurring recipients or recipient groups.

Such methods automatically match the problematic email behavior to suggestions for changing email behavior and to explanations of how the outgoing emails containing the problematic email behavior cause undesirable incoming emails (and such suggestions/explanations are stored in a computer storage) using the processor. The suggestions for changing email behavior include explanations of how to avoid email behavior that is superfluous, confusing, or ineffective; and suggestions to use different social communication formats instead of using an email format. Also, the methods herein automatically compare the problematic email behavior of the email account to goal standards, using the processor, to produce email behavior targets and goals.

Further, these methods can automatically develop such problematic email behavior for multiple email accounts maintained by the email server, to produce problematic email behavior of other email accounts. Thus, such methods can automatically compare the problematic email behavior of the email account to the problematic email behavior of other email accounts, using the processor, to produce societal email behavior comparisons of the email account relative to other email accounts.

The methods herein automatically provide behavioral feedback related to such problematic email behavior (e.g., on a display that is operatively connected to the processor), for example, while the display is displaying the email account. This behavioral feedback includes items such as matching suggestions for changing email behavior, matching explanations of how the outgoing emails containing the problematic email behavior cause undesirable incoming emails, the email behavior targets and goals, the societal email behavior comparisons relative to others, etc. The explanations of how the outgoing emails that contain the problematic email behavior cause undesirable incoming emails provides links between the outgoing emails and behavior of others; and provides an explanation of how the outgoing email impacts the quantity and quality of the incoming emails.

In one example, this behavioral feedback can be automatically displayed and constantly updated using a dashboard containing the behavioral feedback on the display. Such a dashboard includes graphical charts detailing, relative to the email behavior targets and goals the inbox volume, the volume of the incoming emails, the volume of the outgoing emails, the volume differences between new email threads and existing email threads, the ratios of the outgoing emails that remain without reply within the email threads, the mean response time to the outgoing emails, the mean number of incoming emails generated by the outgoing emails, etc. Such graphical charts can track performance over time.

Various systems herein include (among other components) a processor in communication with an email server over a computer network, a display operatively connected to the processor, a computer storage operatively connected to the processor, etc. The email server contains outgoing emails and incoming emails that are sent and received to and from an email account. The processor automatically monitors the outgoing emails and the incoming emails. The outgoing emails can include draft emails that are being prepared to be sent, before being sent. Further, the email server allows the email account to be accessed from multiple computerized devices over the computer network.

The processor automatically compares the outgoing emails and email threads to performance indicators, to identify problematic email behavior. In some examples, the performance indicators include the number of email recipients addressed in the outgoing emails; the subject matter within a regarding line of the outgoing emails; the length, content, and structure of text within a body of the outgoing emails; the number, and size of, attachments to the outgoing emails; the length, breadth, intensity, and continuity of the email threads; the ratios of the outgoing emails that remain without reply within the email threads; the repetitive emails within the email threads; etc. The processor can also compare the outgoing emails and the email threads to the performance indicators using different comparisons based on whether an outgoing email is internal to an organization or external, whether an outgoing email is address to recurring recipients or recipient groups, etc.

The processor automatically matches the problematic email behavior to suggestions for changing email behavior and to explanations of how the outgoing emails containing the problematic email behavior cause undesirable incoming emails (stored in the computer storage). The processor automatically compares the problematic email behavior of the email account to goal standards, to produce email behavior targets and goals.

The processor can also automatically develop the problematic email behavior for multiple email accounts maintained by the email server to produce problematic email behavior of other email accounts. The processor can then automatically compare the problematic email behavior of the email account to the problematic email behavior of other email accounts, to produce societal email behavior comparisons relative to others.

The processor automatically provides behavioral feedback related to the problematic email behavior on the display while the display is displaying the email account. For example, such behavioral feedback can include matching suggestions for changing email behavior, matching explanations of how the outgoing emails containing the problematic email behavior cause undesirable incoming emails, the email behavior targets and goals, the societal email behavior comparisons relative to others, etc. The suggestions for changing email behavior include explanations of how to avoid email behavior that is superfluous, confusing, or ineffective, as well as suggestions to use different social communication formats instead of using an email format.

These explanations of how the outgoing emails containing the problematic email behavior cause undesirable incoming emails can include, for example, links between the outgoing emails and behavior of others, an explanation of how the outgoing email impacts the quantity and quality of the incoming emails, etc.

The processor can provide such behavioral feedback by automatically displaying and constantly updating a dashboard containing the behavioral feedback on the display. Such a dashboard can include graphical charts detailing, relative to the email behavior targets and goals the inbox volume, the volume of the incoming emails, the volume of the outgoing emails, the volume differences between new email threads and existing email threads, the ratios of the outgoing emails that remain without reply within the email threads, the mean response time to the outgoing emails, the mean number of incoming emails generated by the outgoing emails, etc. The graphical charts track performance over time.

These and other features are described in, or are apparent from, the following detailed description.

### BRIEF DESCRIPTION OF THE DRAWINGS

Various exemplary systems and methods are described in detail below, with reference to the attached drawing figures, in which:

FIGS. 1-2 are schematic diagrams illustrating the operation of methods and devices herein;

FIGS. 3-5 are displays created by methods and devices herein;

FIG. 6 is a schematic diagram illustrating operations performed by methods and devices herein;

FIG. 7 is a flow diagram of various methods herein;

FIG. 8 is a schematic diagram illustrating systems herein; and

FIG. 9 is a schematic diagram illustrating devices herein.

### DETAILED DESCRIPTION

As mentioned above, a solution to counterbalance the pervasive use of email and its negative effects would be useful. Therefore, the systems and methods herein provide tackle the problem of email overload in a bottom up fashion, initiating and fostering the reflection on email usage starting at the individual user level, and focusing on informing and educating the user with respect to their email sending behavior. To do so the systems and methods herein provide the user with awareness on their personal email behavior, illustrating in particular the link between their personal behavior and the behavior of others, and how their personal behavior impacts the quantity and quality of email they receive.

The overall approach the systems and methods herein adopt includes the following elements. The first is initial self-assessment. The initial self-assessment triggers reflection and provides the user or employee with awareness of their personal behavior. Indeed, while the individual employee is often aware of problematic email behaviors existing in general within the organization, they do not associate such to themselves. The second is ambient awareness monitors. High-level ambient awareness monitors provide the user with continuous self-awareness of their behavior in real time. They trigger and maintain reflection over time and show whether changes put in place are effective. They illustrate as well how their personal behaviors are related to the behaviors of others. The third is consumption, targets, and tips. Consumption, targets and tips help the user to understand what their bad habits are. These indicators are personal, but also compared to the aggregated average behavior of other similar users. Consumptions and targets help to associate the notion of cost and savings to the (change in) behavior, and tips give hints about what could or should be changed to improve. Targets can also involve the behaviors of others. For instance, a target can be to reduce the amount of email received from particular email exchange partners.

The methods and systems herein focus on the email a user sends, rather than the email they receive, define basic metrics and appropriate key performance indicators (KPIs) to highlight the user's possibly problematic email practices, illustrate the link between the sent and received email in the sense that the quantity and quality of email a user receives is closely related to the quantity and quality of email they send. Therefore, the analysis also addresses the user's incoming email to identify the user's recurring email exchange partners or groups; and to relate, with respect to those identified exchange partners or groups, the amount and characteristics of email received from them with the amount and characteristics email sent to them. Further, the systems and methods herein perform the analysis exclusively on the user's personal mailbox, thereby avoiding any privacy threats for the user.

The aim of this disclosure is to provide email users with awareness about their own good or bad emailing practices, primarily with respect to their email sending behavior, rather than helping them to better deal with their overloaded Inbox. Bad email sending practices constitute indeed one of the main root causes of email overload and the aim herein is to highlight and address this root cause rather than palliating its effects. There is also evidence that by helping the individual to adopt better practices with sending email (i.e., by acting on what is under the individual's personal control) the incoming mailbox volume can also be reduced; and this is because these best practices will spread to others because if everyone starts to be conscious and thoughtful about the emails they sends and aims at reducing the outgoing volume, the volume of incoming email in return will get lower as well. This is particularly true when the intervention involves the executive layer.

Various metrics and KPIs are used by the systems and methods herein to detect possibly problematic email behaviors. Possibly ineffective emailing behaviors can exist and become apparent at three levels, the individual email considered in isolation, the thread or exchange an email belongs to, or through the way the user reacts on and replies to particular incoming email messages depending on the overall status of their mailbox. To identify bad practices on each of those levels the systems and methods herein therefore analyze the characteristics of the 1) individual email sent out by the user considered in isolation, 2) email exchanges or threads in which the user participates, 3) user's inbox and the way they reacts on and responds to incoming email.

With respect to individual email characteristics, one aim of this disclosure is to provide users with awareness of emails they send that can be considered as superfluous, confusing, or ineffective; and that are therefore a good candidate to question. The following attributes and characteristics allow detecting such emails (and each email can be problematic with respect to several of these characteristics at the same time). One attribute is the number of recipients, because emails with a large number of recipients (To, CC, Bcc etc.) are typically not very focused or efficient.

Another attribute is the email subject, because concise email subjects with recognizable speech acts allow the receiver to quickly understand the purpose of an email and to react efficiently. Speech acts have been recognized as a backbone of collaboration and coordination in the work place. Authors have provided taxonomies of what these are, and they are indeed an efficient way to let the recipient understand the purpose of an email (e.g., if it is a request to do something or only a provision of information). Furthermore, in work emails additional context, (e.g., the project the email relates to) can be stated in the email subject, content, or introduction to make the exchange more efficient. Work organizations can define corresponding policies that can then automatically be detected and verified.

An additional attribute is email length, content, and structure. Beyond the email subject, the email length, content, and structure are important indicators for unclear and thus inefficient communication. Long emails with unstructured textual content are not easy to grasp for the receiver, and thus not very efficient. The longer the email text, the more a good structure is important, for instance an introduction with a first paragraph explaining the purpose and structure of the remainder. Similarly, email without proper content (e.g., simply forwarding another email or distributing a document or link without explanatory text) should be avoided.

A further attribute is the number and size of attachments. Emails with attachments and especially with large attachments, illustrate the lack of (use of) shared repositories. Instead of sharing one unique document through a shared repository the attached document email attachments create one independent duplicate for each recipient, thus unnecessarily using and wasting additional resources like bandwidth and memory.

With respect to email exchange or thread characteristics, efficient email typically materializes as a short and focused exchange between two (or a few) individuals. The following email exchange or thread attributes and characteristics thus allow the detection of different and inefficient email exchanges. One attribute is the thread length, breadth, intensity, and continuity over time, because long, broad, intense and continuous email exchanges typically correspond to discussion threads that are better supported by other systems, more appropriate for long lasting conversations in focused groups such as project teams. An additional attribute is the proportion of outgoing versus incoming emails that remain without reply, and that do not turn into an exchange allows the systems and methods to measure the user's communicative effectiveness and responsiveness. The systems and methods herein analyze the user's communicative effectiveness by computing among the email the user sends the ratio of the messages that do not turn into a proper exchange and remain without reply. Similarly, the systems and methods herein analyze the communicative responsiveness of the user by computing, among the email the user receives, the ratio of messages to which the user does not reply (this concerns only the emails received by the user directly (i.e., where the user was in To and not in CC). Another attribute is repetitive emails (resending of approximately the same content to the approximately the same recipients). Repetitive emails are inefficient as such, because they either correspond to corrected and/or updated versions of their predecessor or constitute simple reminders.

Over time, the analysis of the user's email exchanges and, in particular of their email exchange partners, helps to put the user's behavior in context. This involves distinguishing internal and external emails (i.e., email sent to recipients inside the organization versus outside the organization (or mixed)). There might indeed be a difference in behavior between emails exchanged with direct collaborators only (internal email) versus email involving external partners. Additionally, the systems and methods herein identify recurring recipients or recipient groups. The identification of recurring exchange partners allows the systems and methods herein to analyze how the exchange with them evolves over time, and to understand whether the corresponding email practices evolve. The system also analyzes cases when email is used for other purposes (e.g., emails sent to the sender himself only which correspond generally to reminders or “to do” items).

With respect to mailbox characteristics, the situation of email overload itself impacts the users' emailing behavior because users can take time to carefully read all their incoming and formulate all their outgoing emails in “normal” (i.e., non-overload situations); whereas, they can not do this when under pressure (i.e., in heavy overloaded situations). The impact can be different for email exchanges with internal, and with external, partners. For instance, email exchanges with external partners can be taken more seriously and thus less impacted by email overload than internal email exchanges, as they reduce the portion of answered emails. To analyze the actual situation for each user and understand whether the actual situation corresponds to a no, a minor, or heavy email overload; the systems and methods herein monitor each user's mailbox over time. Therefore, the systems and methods herein contextualize it with respect to the user's general email management characteristics (i.e., being a no filer, a frequent filer, or a spring cleaner).

The following general mailbox attributes and characteristics allow the systems and methods herein to identify the current status of email overload for a given user, and to see how the user's email behavior evolves over time. Such attributes include the evolution of the overall size of mailbox in terms of number of emails in the Inbox; evolution of the number of threads and length of threads in the inbox to know how emails are managed (categorized or leave as it is in the mailbox); evolution in each unhealthy category described in the previous sections (e.g., use of attachments, emails without reply etc.); etc.

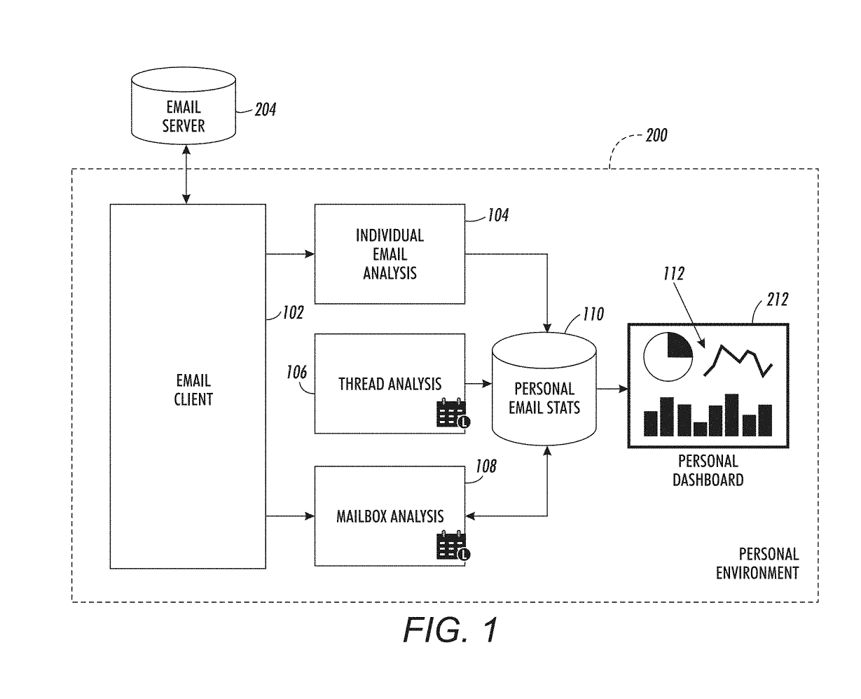

FIG. 1 is an illustration of one of many possible displays that can be provided on a graphic user interface 212. In some examples, the systems and methods herein are implemented as an email client 102 (or a plug-in to an email client 102) such as outlook, operating on a computerized device 200 that is able to intercept incoming and outgoing emails thanks to a synchronization with an email server 204. The system is voluntarily delocalized on the user's personal computer 200 to respect their privacy. In order to enable synchronization across devices, the database can be part of the user profile on windows, for example.

As shown, the email client 102 keeps a connection with the email server 204 to intercept incoming and outgoing emails. Each time a new email is leaving or entering the mailbox, the individual email analysis 104 process is activated. The individual email analysis 104 process computes the metrics and KPIs for this email and stores the results together with the email meta-data in the personal database 110. This process can use different tools, such as for instance linguistic parsers, to extract information.

Every time a new email is processed, or at a regular periods of time, the thread analysis 106 process is activated. This process associates the new emails (new with respect to the last time the process executed) to existing or new threads. Therefore, the thread analysis 106 process exploits the email metadata stored in the personal email stats database 110. The thread analysis 106 process updates the thread-based KPIs integrating the information corresponding to the new emails. The results are stored in the personal database 110.

Periodically (e.g., at scheduled times) the mailbox analysis 108 process is activated. The mailbox analysis 108 process verifies whether the user has read, deleted and/or moved emails between folders (i.e., whether they have been kept in the inbox or archived in another folder). The processed information is then stored in the personal database 110 with a new time stamp, in order to detect change over time. The personal email stats database 110 stores all relevant information, i.e., email meta-data, email thread descriptions, information about the user's mailbox organization and all the computed KPIs.

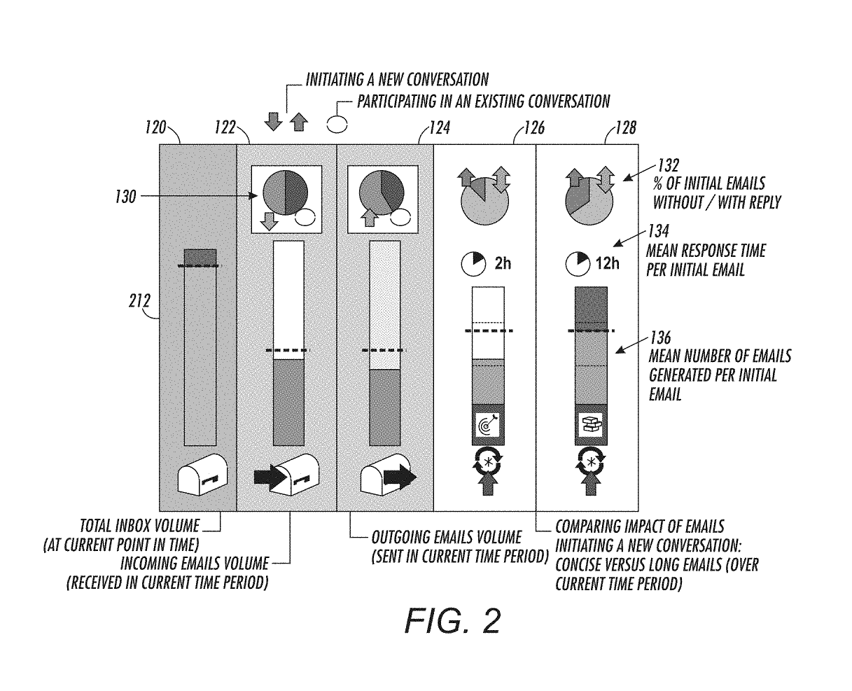

Also, a display 212 displays a personal dashboard 112 that accesses the email KPIs and usage information from the database 110. The personal dashboard 112 highlights the user's good and bad habits, and their impact. FIG. 2 illustrates one example of how the personal dashboard 112 can appear. As can be seen in FIG. 2, the personal dashboard 112 can contain information about the overall status of the user's inbox, the number of emails the user received and sent within the current time period, more detailed information about the user's email efficacy, etc.

With respect to the overall status of the user's mailbox, the personal dashboard 112 can display graphic elements that indicate whether the user's mailbox contains the usual load or amount of unread email (or more, or less) for total inbox volume 120, incoming email volume 122, outgoing email volume 124, etc. As shown in FIG. 2, the graphic elements 120-124 include bar charts that are presented relative to a dashed line (indicating the mean volume) and the bars change color to indicate extreme situations (very high or very low volumes, etc.). With respect to the number of emails received and sent by the user, the personal dashboard 112 can display graphic elements, such as pie charts 130, that indicate how much of the email volume corresponds to new conversations and how much corresponds to already existing threads.

The email efficacy part will inform the user about the impact of the emails they sent out. For instance, for the emails the user sent out initiating a new conversation, graphic elements 126-128 can display bar charts showing how many follow up emails these emails generated, on average; what the mean response time to these emails was, and what proportion of these emails have or have not yet received a reply. In the example shown in FIG. 2, graphic element 126 represents short, concise emails; while, graphic element 128 represents outgoing emails with unclear, un-concise subject, or with long unstructured content. Graphic element 132 is a pie chart showing the percentage of initial emails with, and without, an initial reply; graphic element 134 is a clock showing the mean response time per initial email; graphic element 136 is a bar chart showing the mean number of emails generated per initial email.

In the example shown in FIG. 2, the user dashboard 112 shows from left to right in the first column 120 that the user's inbox contains currently slightly more unread emails than the dashed line representing usual amounts; in the second (and third) columns 122-124 that the user has received (and sent out) slightly less emails than the dashed line representing usual amounts (which is rather positive); and, finally, in the last two columns 126-128 that the user might want to try writing shorter emails: indeed the short emails sent (represented by graphic element 126) the user received a reply more often (132) and faster (134) and generated overall less follow-up email traffic (136) in comparison to longer ones (represented by graphic element 128).

Therefore, as shown above, specific indicators can highlight the difference in impact that effective, versus ineffective, emailing behavior has; by, for instance, highlighting the impact of emails with an unclear, un-concise subject, or with long unstructured content. The dashboard 112 can be dynamically adapted to highlight the particular characteristics where the user's email behavior is ineffective. The interface can also indicate the evolution of the corresponding behavior over time (i.e., whether the user is improving or not) by comparing the user's actual behavior with their historical average and indicating positive or negative evolution (e.g., using different colors in the bar charts, etc.).

Therefore, the systems and methods herein replace or reduce the required training by automatically computing measures about bad practices and providing them to the user for permanent awareness (thus going beyond the sheer sent email volume).

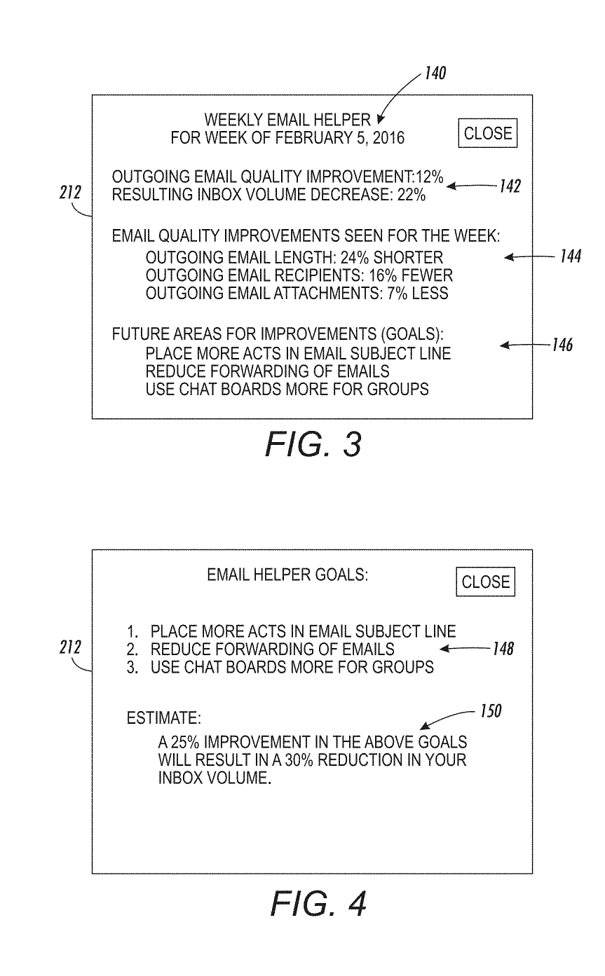

FIG. 3 is another example of displays that can be provided on the graphic user interface 212. The display in FIG. 3 provides an email helper, which can be displayed to the user periodically (e.g., daily, weekly, monthly, etc.), as shown by item 140. Various issues can be explained using text and/or graphic to demonstrate the links between the outgoing emails and behavior of others; and the display can provide an explanation of how the outgoing email impacts the quantity and quality of the incoming emails. For example, in area 142, the display in FIG. 3 explains that the user has improved their email quality by 12% during the most recent period (e.g., last week), and that this has resulted in a 22% decrease in inbox volume. The improvement in email quality percentage can be calculated using many different criteria, such as averaging and/or weighting user statistics on email length, number of recipients, number of attachments, ratio of emails that others have replied to, length of time for replies, etc.; or other formulations of indicators can be used to judge the change in email quality.

Such a helper display 140 can also specify which contributors to email quality saw the greatest improvement over the last period (e.g., the top three indicators), where item 144 in FIG. 3 describes that the user's outgoing emails were 24% shorter, had 16% fewer recipients, and had 7% less attachments. Similarly, the helper display 140 can specify which contributors to email quality saw the greatest improvement over the last period (e.g., the top three indicators), where item 146 in FIG. 3 describes that the user could improve their email quality by placing more acts in the email subject line, could reduce the amount of emails that are forwarded to others, and that they could use chat boards instead of emails to conduct group communications. Note that the display 212 could list more or less user improvements 144 and user suggestions 146, but that this example selected the top three for presentation to the user.

FIG. 4 is another example of displays that can be provided on the graphic user interface 212. The display in FIG. 4 provides goals, where the listed goals 148 are the same used in the example in FIG. 3. In addition, FIG. 4 provides a text estimate 150 of how much reduction in inbox volume would be expected from achieving partial progress (e.g., 25%) on the goals 148, to provide an explanation of how the outgoing email impacts the quantity and quality of the incoming emails. Such estimates 150 can be calculated on a number of different formulations and/or models; which may be based, for example, on empirical evidence of other user's inbox reductions that occurred when such goals were partially or fully achieved. The display in FIG. 4 can be provided at many different timings, such as periodically according to a regular schedule, when the user's outgoing email quality statistics begin to decrease, each time a user opens their email application, etc.

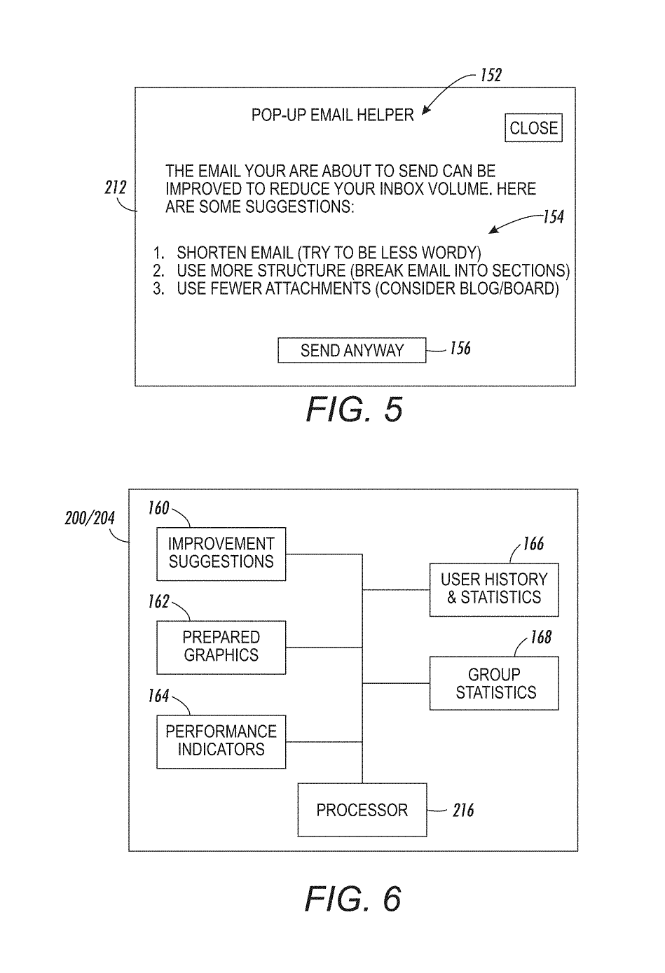

FIG. 5 is another example of displays that can be provided on the graphic user interface 212. The display in FIG. 5 can be, for example, a pop-up type display 152 (e.g., a smaller display box that temporarily overlays other display windows) that automatically opens when a user is sending an email that has quality issues (e.g., after the user executes the “send” button on an email). For example, if more than a specific number of email indicators are exceeded (e.g., more that 3 of: email length limit exceeded, number of recipients limit exceeded, number of attachments limit exceeded, quality of subject line percentage limit exceeded, etc.), or other standards are not met, the pop-up window 152 automatically is made to appear on the display 212.

In FIG. 5, the user is provided specific suggestions 154, such as to make the email that is being sent shorter (less wordy), for the user to add more structure to the email by breaking the email into sections (e.g., to improve the recipient's understanding, and potentially reduce the number of email responses that ask for clarification), to remove some of the attachments, etc. The suggestions 154 are generally related to the email quality issues that triggered the appearance of the pop-up box 152. Also, the user can be provided with an option to not adjust the email 156, and for the email to be sent anyway with the identified quality issues.

Additionally, any of the text shown in FIGS. 3-5 can be hyperlinks or macros that link to more complete descriptions and/or graphics, which execute when the user hovers a pointer over, or uses the pointer to select (e.g., click on) the text.

FIG. 6 illustrates components that can be used to achieve the processing described herein. While many more components could be included with systems herein, FIG. 6 illustrates that a processor 216 has access to previously established improvement suggestions 160, prepared graphics 162, performance indicators (with limits) 164. Further, the processor 216 has access to the user's history and statistics 166, as well as group statistics 168 of other similar users. With this, the processor 216 can monitor the user's outgoing and thread emails to determine if limits of any performance indicators 164 are exceeded. The processor 216 can also automatically create displays (such as displays 212 shown in FIGS. 3-5) by matching the indicator limits that were exceeded to specific ones of the improvement suggestions 160, corresponding prepared graphics 162, etc.; and by incorporating user history and statistics 166, using group statistics 168 for comparison, etc.

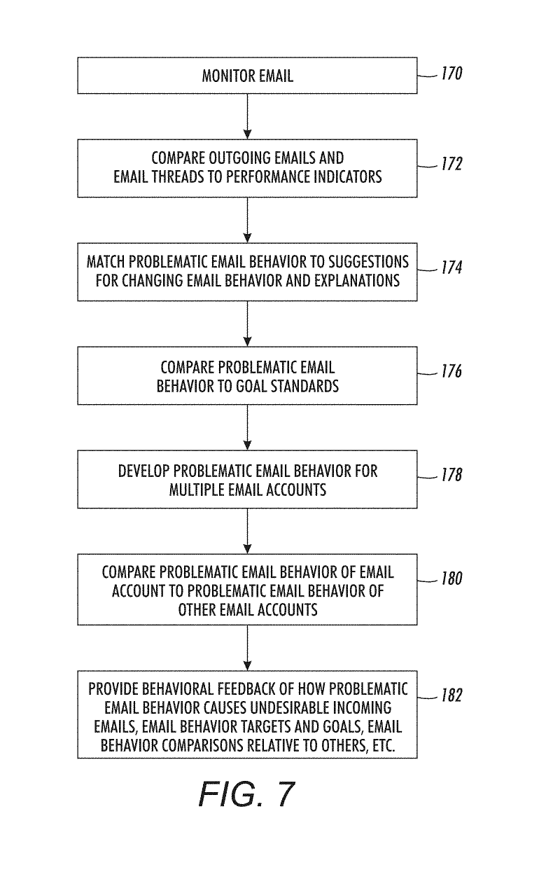

FIG. 7 is flowchart illustrating exemplary methods herein. In item 170, these methods automatically monitor an email account by, for example, monitoring an email server containing outgoing emails and incoming emails that are sent and received to and from the email account (e.g., using a processor in communication with the email server over a computer network). The outgoing emails can also include draft emails that are being prepared to be sent, before being sent (e.g., after the user clicks on the send button, but before the email program actually sends the email), and the email server allows the email account to be accessed from multiple computerized devices over the computer network.

In item 172, these methods automatically compare the outgoing emails and email threads to the limits of performance indicators (where a series of the outgoing emails and related incoming emails form the email threads), using the processor, to identify the problematic email behavior. The performance indicators can include limits on, for example, the number of email recipients addressed in the outgoing emails; the subject matter within a regarding line of the outgoing emails; the length, content, and structure of text within a body of the outgoing emails; the number, and size of, attachments to the outgoing emails; the length, breadth, intensity, and continuity of the email threads; the ratios of the outgoing emails that remain without reply within the email threads; the repetitive emails within the email threads; etc.

The process of comparing the outgoing emails and email threads to the performance indicator limits in item 172 can use different comparisons (e.g., different weights, different performance indicator limits, etc.) based on whether an outgoing email is internal to an organization or external, and whether an outgoing email is address to recurring recipients or recipient groups.

In item 174, such methods automatically match the problematic email behavior to suggestions for changing email behavior and to explanations of how the outgoing emails containing the problematic email behavior cause undesirable incoming emails (and such suggestions/explanations are stored in a computer storage) using the processor. The suggestions for changing email behavior include explanations of how to avoid email behavior that is superfluous, confusing, or ineffective; and suggestions to use different social communication formats (e.g., blogs, boards, posts, document repositories, etc.) instead of using an email format. Also, in item 176, the methods herein automatically compare the problematic email behavior of the email account to goal standards (e.g., percentage improvements, averages, other user's performance changes, etc.), using the processor, to produce email behavior targets and goals.

The process of matching the performance indicator limits that are exceeded to suggestions in item 176 can take many forms. For example, the matching explanation/suggestion can simply be the display of the user's performance relative to a goal, or previous performance average, as shown in FIG. 2. Thus, for example, the user's inbox volume can be shown relative to their historical inbox volume, to allow the user to observe changes; and graphic volumes of responses to concise emails vs. lengthy emails can be simply displayed.

Alternatively, the process of matching the performance indicator limits violations to suggestions in item 176 can occur based on previously established logical relationships between the performance indicators and the explanations/suggestions that may be maintained with the suggestions, e.g., in item 160 (FIG. 6). For example, all limit violations of the number of email recipients, number or length of attachments, email length, etc., can be logically matched to messages to reduce the number or length; all limit violations of the subject matter within a regarding line can be logically matched to messages to use more acts or action words in the regarding line; all limit violations of the content, and structure of text within a body of the outgoing emails can be logically matched to messages to add more structure to the content in the body; all limit violations of the length, breadth, intensity, and continuity of the email threads can be logically matched to messages to use alternative non-email boards or resources to conduct such communications; etc.

Further, in item 178, these methods can automatically use the same processes to develop such problematic email behavior for multiple email accounts maintained by the email server, to produce problematic email behavior of other email accounts. Thus, in item 180, such methods can automatically compare the problematic email behavior of the email account to the problematic email behavior of other email accounts, using the processor, to produce societal email behavior comparisons of the email account relative to other email accounts.

In item 182, these methods automatically provide behavioral feedback related to such problematic email behavior (e.g., on a display that is operatively connected to the processor), for example, while the display is displaying the email account. This behavioral feedback provided in item 182 includes items such as matching suggestions for changing email behavior, matching explanations of how the outgoing emails containing the problematic email behavior cause undesirable incoming emails, the email behavior targets and goals, the societal email behavior comparisons relative to others, etc. The explanations of how the outgoing emails that contain the problematic email behavior cause undesirable incoming emails provides links between the outgoing emails and behavior of others; and provides an explanation of how the outgoing email impacts the quantity and quality of the incoming emails.

In one example, the behavioral feedback in 182 can be automatically displayed and constantly updated using a dashboard containing the behavioral feedback on the display. Such a dashboard can include graphical charts detailing, relative to the email behavior targets and goals the inbox volume, the volume of the incoming emails, the volume of the outgoing emails, the volume differences between new email threads and existing email threads, the ratios of the outgoing emails that remain without reply within the email threads, the mean response time to the outgoing emails, the mean number of incoming emails generated by the outgoing emails, etc. Such graphical charts can track performance over time.

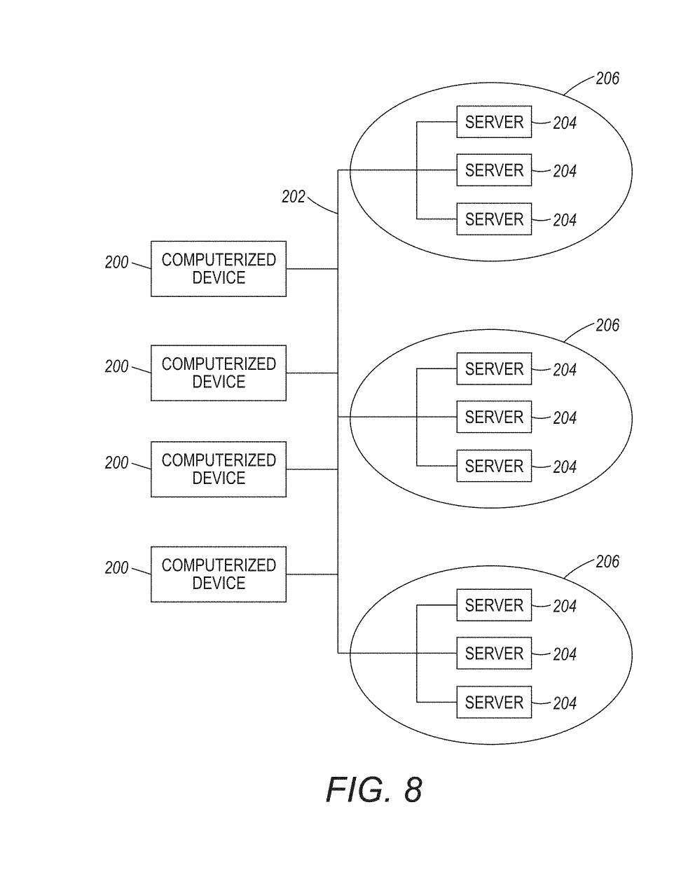

As shown in FIG. 8, exemplary systems and methods herein include various computerized devices 200, 204 located at various different physical locations 206. The computerized devices 200, 204 can include print servers, printing devices, personal computers, etc., and are in communication (operatively connected to one another) by way of a local or wide area (wired or wireless) network 202.

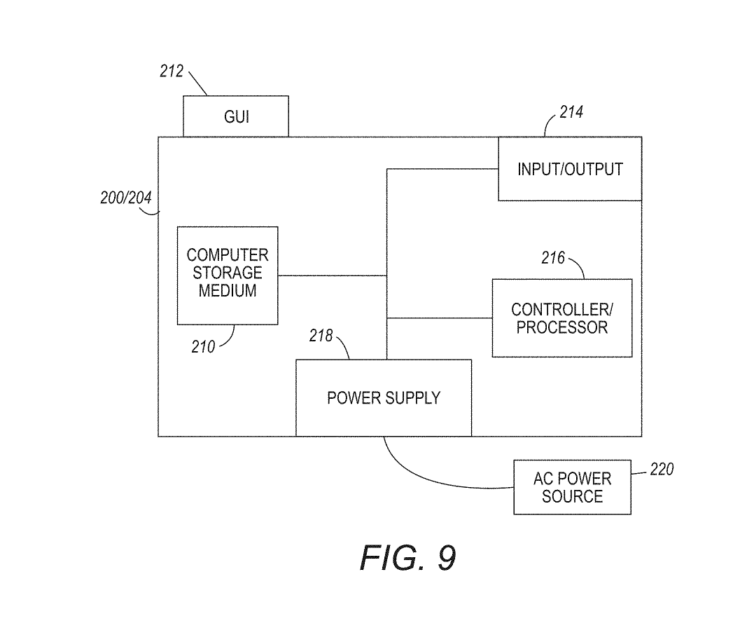

FIG. 9 illustrates a computerized device 200/204, which can be used with systems and methods herein and can comprise, for example, a print server, a personal computer, a portable computing device, etc. The computerized device 200/204 includes a controller/tangible processor 216 and a communications port (input/output) 214 operatively connected to the tangible processor 216 and to the computerized network 202 external to the computerized device 200/204. Also, the computerized device 200/204 can include at least one accessory functional component, such as a graphical user interface (GUI) assembly 212. The user can receive messages, instructions, and menu options from, and enter instructions through, the graphical user interface or control panel 212.

The input/output device 214 is used for communications to and from the computerized device 200/204 and comprises a wired device or wireless device (of any form, whether currently known or developed in the future). The tangible processor 216 controls the various actions of the computerized device. A non-transitory, tangible, computer storage medium device 210 (which can be optical, magnetic, capacitor based, etc., and is different from a transitory signal) is readable by the tangible processor 216 and stores instructions that the tangible processor 216 executes to allow the computerized device to perform its various functions, such as those described herein. Thus, as shown in FIG. 9, a body housing has one or more functional components that operate on power supplied from an alternating current (AC) source 220 by the power supply 218. The power supply 218 can comprise a common power conversion unit, power storage element (e.g., a battery, etc), etc.

Therefore, various systems herein include (among other components) a processor 216 in communication with an email server over a computer network, a display 212 operatively connected to the processor 216, a computer storage 210 operatively connected to the processor 216, etc. The email server contains outgoing emails and incoming emails that are sent and received to and from an email account. The processor 216 automatically monitors the outgoing emails and the incoming emails. The outgoing emails can include draft emails that are being prepared to be sent, before being sent. Further, the email server allows the email account to be accessed from multiple computerized devices over the computer network.

The processor 216 automatically compares the outgoing emails and email threads to performance indicators, to identify problematic email behavior. In some examples, the performance indicators include the number of email recipients addressed in the outgoing emails; the subject matter within a regarding line of the outgoing emails; the length, content, and structure of text within a body of the outgoing emails; the number, and size of, attachments to the outgoing emails; the length, breadth, intensity, and continuity of the email threads; the ratios of the outgoing emails that remain without reply within the email threads; the repetitive emails within the email threads; etc. The processor 216 can also compare the outgoing emails and the email threads to the performance indicators using different comparisons based on whether an outgoing email is internal to an organization or external, whether an outgoing email is address to recurring recipients or recipient groups, etc.

The processor 216 automatically matches the problematic email behavior to suggestions for changing email behavior and to explanations of how the outgoing emails containing the problematic email behavior cause undesirable incoming emails (stored in the computer storage 210). The processor 216 automatically compares the problematic email behavior of the email account to goal standards, to produce email behavior targets and goals.

The processor 216 can also automatically develop the problematic email behavior for multiple email accounts maintained by the email server to produce problematic email behavior of other email accounts. The processor 216 can then automatically compare the problematic email behavior of the email account to the problematic email behavior of other email accounts, to produce societal email behavior comparisons relative to others.

The processor 216 automatically provides behavioral feedback related to the problematic email behavior on the display 212 while the display 212 is displaying the email account. For example, such behavioral feedback can include matching suggestions for changing email behavior, matching explanations of how the outgoing emails containing the problematic email behavior cause undesirable incoming emails, the email behavior targets and goals, the societal email behavior comparisons relative to others, etc. The suggestions for changing email behavior include explanations of how to avoid email behavior that is superfluous, confusing, or ineffective, as well as suggestions to use different social communication formats instead of using an email format.

These explanations of how the outgoing emails containing the problematic email behavior cause undesirable incoming emails can include, for example, links between the outgoing emails and behavior of others, an explanation of how the outgoing email impacts the quantity and quality of the incoming emails, etc.

The processor 216 can provide such behavioral feedback by automatically displaying and constantly updating a dashboard containing the behavioral feedback on the display 212. Such a dashboard can include graphical charts detailing, relative to the email behavior targets and goals the inbox volume, the volume of the incoming emails, the volume of the outgoing emails, the volume differences between new email threads and existing email threads, the ratios of the outgoing emails that remain without reply within the email threads, the mean response time to the outgoing emails, the mean number of incoming emails generated by the outgoing emails, etc. The graphical charts track performance over time.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, tangible processors, etc.) are well-known and readily available devices produced by manufacturers such as Dell Computers, Round Rock Tex., USA and Apple Computer Co., Cupertino Calif., USA. Such computerized devices commonly include input/output devices, power supplies, tangible processors, electronic storage memories, wiring, etc., the details of which are omitted herefrom to allow the reader to focus on the salient aspects of the systems and methods described herein. Further, the terms automated or automatically mean that once a process is started (by a machine or a user), one or more machines perform the process without further input from any user. In the drawings herein, the same identification numeral identifies the same or similar item.

It will be appreciated that the above-disclosed and other features and functions, or alternatives thereof, can be desirably combined into many other different systems or applications. Various presently unforeseen or unanticipated alternatives, modifications, variations, or improvements therein can be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

What is claimed is:

1. A method comprising:
automatically monitoring outgoing emails that are sent from an email account, using a processor;
automatically comparing said outgoing emails to performance indicators, using said processor, to identify problematic email behavior;
automatically matching said problematic email behavior to suggestions for changing email behavior and to explanations of how said outgoing emails containing said problematic email behavior cause undesirable incoming emails, stored in a computer storage, using said processor;
automatically comparing said problematic email behavior of said email account to goal standards, using said processor, to produce email behavior targets and goals;
automatically comparing said problematic email behavior of said email account to problematic email behavior of other email accounts, using said processor, to produce societal email behavior comparisons relative to others;
automatically providing behavioral feedback related to said problematic email behavior on a display operatively connected to said processor while said display is displaying said email account,
said behavioral feedback comprises:
matching ones of said suggestions for changing email behavior;
matching ones of said explanations of how said outgoing emails containing said problematic email behavior cause undesirable incoming emails;
said email behavior targets and goals; and
said societal email behavior comparisons relative to others.

2. The method according to claim 1, said providing behavioral feedback comprises automatically displaying and constantly updating a dashboard containing said behavioral feedback on said display.

3. The method according to claim 2, said dashboard includes graphical charts detailing, relative to said email behavior targets and goals:
inbox volume;
volume of said outgoing emails;
volume differences between new ones of email threads and existing ones of said email threads;
ratios of said outgoing emails that remain without reply within said email threads;
mean response time to said outgoing emails; and
mean number of incoming emails generated by said outgoing emails.

4. The method according to claim 3, said graphical charts track performance over time.

5. The method according to claim 1, said explanations of how said outgoing emails containing said problematic email behavior cause undesirable incoming emails includes:
links between said outgoing emails and behavior of others; and
an explanation of how said outgoing email impacts the quantity and quality of said incoming emails.

6. The method according to claim 1, said comparing said outgoing emails to said performance indicators uses different comparisons based on whether:
an outgoing email is internal to an organization or external; or
an outgoing email is address to recurring recipients or recipient groups.

7. The method according to claim 1, said suggestions for changing email behavior include:
explanations of how to avoid email behavior that is superfluous, confusing, or ineffective; and
suggestions to use different social communication formats instead of using an email format.

8. A method comprising:
automatically monitoring an email server containing outgoing emails and incoming emails that are sent and received to and from an email account, using a processor in communication with said email server over a computer network, said outgoing emails include draft emails that are being prepared to be sent, before being sent, and said email server allows said email account to be accessed from multiple computerized devices over said computer network;
automatically comparing said outgoing emails to performance indicators, using said processor, to identify problematic email behavior;
automatically comparing a series of said outgoing emails and related ones of said incoming emails forming email threads to said performance indicators, using said processor, to identify said problematic email behavior, said performance indicators comprise:
a number of email recipients addressed in said outgoing emails;
a subject matter within a regarding line of said outgoing emails;
length, content, and structure of text within a body of said outgoing emails;
a number, and size of, attachments to said outgoing emails;
length, breadth, intensity, and continuity of said email threads;
ratios of said outgoing emails that remain without reply within said email threads; and
repetitive emails within said email threads,
automatically matching said problematic email behavior to suggestions for changing email behavior and to explanations of how said outgoing emails containing said problematic email behavior cause undesirable incoming emails, stored in a computer storage, using said processor;
automatically comparing said problematic email behavior of said email account to goal standards, using said processor, to produce email behavior targets and goals;
automatically developing said problematic email behavior for multiple email accounts maintained by said email server to produce problematic email behavior of other email accounts;
automatically comparing said problematic email behavior of said email account to said problematic email behavior of other email accounts, using said processor, to produce societal email behavior comparisons relative to others;
automatically providing behavioral feedback related to said problematic email behavior on a display operatively connected to said processor while said display is displaying said email account,
said behavioral feedback comprises:
matching ones of said suggestions for changing email behavior;
matching ones of said explanations of how said outgoing emails containing said problematic email behavior cause undesirable incoming emails;
said email behavior targets and goals; and
said societal email behavior comparisons relative to others.

9. The method according to claim 8, said providing behavioral feedback comprises automatically displaying and constantly updating a dashboard containing said behavioral feedback on said display.

10. The method according to claim 9, said dashboard includes graphical charts detailing, relative to said email behavior targets and goals:
volume of said incoming emails;
volume of said outgoing emails;
volume differences between new ones of said email threads and existing ones of said email threads;
said ratios of said outgoing emails that remain without reply within said email threads;
mean response time to said outgoing emails; and
mean number of incoming emails generated by said outgoing emails.

11. The method according to claim 10, said graphical charts track performance over time.

12. The method according to claim 8, said explanations of how said outgoing emails containing said problematic email behavior cause undesirable incoming emails includes:
links between said outgoing emails and behavior of others; and
an explanation of how said outgoing email impacts the quantity and quality of said incoming emails.

13. The method according to claim 8, said comparing said outgoing emails to said performance indicators, and said comparing said email threads to said performance indicators use different comparisons based on whether:
an outgoing email is internal to an organization or external; or
an outgoing email is address to recurring recipients or recipient groups.

14. The method according to claim 8, said suggestions for changing email behavior include:
explanations of how to avoid email behavior that is superfluous, confusing, or ineffective; and
suggestions to use different social communication formats instead of using an email format.

15. A system comprising:
a processor in communication with an email server over a computer network;
a display operatively connected to said processor; and
a computer storage operatively connected to said processor,
said email server contains outgoing emails and incoming emails that are sent and received to and from an email account,
said processor automatically monitors said outgoing emails and said incoming emails,
said outgoing emails include draft emails that are being prepared to be sent, before being sent,
said email server allows said email account to be accessed from multiple computerized devices over said computer network,
said processor automatically compares said outgoing emails to performance indicators, to identify problematic email behavior,
said processor automatically compares a series of said outgoing emails and related ones of said incoming emails forming email threads to said performance indicators, to identify said problematic email behavior,
said performance indicators comprise:
a number of email recipients addressed in said outgoing emails;
a subject matter within a regarding line of said outgoing emails;
length, content, and structure of text within a body of said outgoing emails;
a number, and size of, attachments to said outgoing emails;
length, breadth, intensity, and continuity of said email threads;
ratios of said outgoing emails that remain without reply within said email threads; and
repetitive emails within said email threads,
said processor automatically matches said problematic email behavior to suggestions for changing email behavior and to explanations of how said outgoing emails containing said problematic email behavior cause undesirable incoming emails, stored in said computer storage,
said processor automatically compares said problematic email behavior of said email account to goal standards, to produce email behavior targets and goals, said processor automatically develops said problematic email behavior for multiple email accounts maintained by said email server to produce problematic email behavior of other email accounts,
said processor automatically compares said problematic email behavior of said email account to said problematic email behavior of other email accounts, to produce societal email behavior comparisons relative to others,
said processor automatically provides behavioral feedback related to said problematic email behavior on said display while said display is displaying said email account,
said behavioral feedback comprises:
matching ones of said suggestions for changing email behavior;
matching ones of said explanations of how said outgoing emails containing said problematic email behavior cause undesirable incoming emails;
said email behavior targets and goals; and
said societal email behavior comparisons relative to others.

16. The system according to claim 15, said processor provides said behavioral feedback by automatically displaying and constantly updating a dashboard containing said behavioral feedback on said display.

17. The system according to claim 16, said dashboard includes graphical charts detailing, relative to said email behavior targets and goals:
volume of said incoming emails;
volume of said outgoing emails;
volume differences between new ones of said email threads and existing ones of said email threads;
said ratios of said outgoing emails that remain without reply within said email threads;
mean response time to said outgoing emails; and
mean number of incoming emails generated by said outgoing emails.

18. The system according to claim 17, said graphical charts track performance over time.

19. The system according to claim 15, said explanations of how said outgoing emails containing said problematic email behavior cause undesirable incoming emails includes:
links between said outgoing emails and behavior of others; and
an explanation of how said outgoing email impacts the quantity and quality of said incoming emails.

20. The system according to claim 15, said processor compares said outgoing emails to said performance indicators, and said compares said email threads to said performance indicators use different comparisons based on whether:
an outgoing email is internal to an organization or external; or
an outgoing email is address to recurring recipients or recipient groups, and said suggestions for changing email behavior include:
explanations of how to avoid email behavior that is superfluous, confusing, or ineffective; and
suggestions to use different social communication formats instead of using an email format.
